(19) United States
(12) Patent Application Publication
(10) Pub. No.: US 2009/0024558 A1
(43) Pub. Date: Jan. 22, 2009

(54) Methods and systems for storing and retrieving rejected data

(75) Inventors: Roland Brethauer, Mannheim (DE); Jens Layer, IIsfeld (DE); Hendrik Lock, Linkenheim-Hochstetten (DE); Aravind Ravindranath, Bangalore (IN); Ramprasadh Kothandaraman, Bangalore (IN)

Correspondence Address: SAP / FINNEGAN, HENDERSON LLP, 901 NEW YORK AVENUE, NW, WASHINGTON, DC, 20001-4413, US

(73) Assignee: SAP AG

(21) Appl. No.: 11/826,398

(22) Filed: Jul. 16, 2007

(51) Int. Cl. G06F 7/00

(52) U.S. Cl. 707/1; 707/10

(57) ABSTRACT

Methods, computer-readable media, and systems are provided to facilitate the storage, retrieval, and display of rejected data objects. Even when a data object is accepted on a user system, the data object may be rejected before reaching a backend repository if the user system and backend repository are asynchronously connected. In one implementation, a rejected data object is collected, converted into a storage format, and stored on a storage medium. Information relating the rejected data object in the storage format to a first data model is also stored. At some future time, a request is received and utilized to locate the rejected data object. Then, the rejected data object is translated from a storage format into the first object format by using the relational information. A value from the translated rejected data object can then be displayed contemporaneously with a second data value from an accepted data object. This may allow a user to see transactions and data that might otherwise be lost. Further, this may allow a system analyst to correct system problems when abnormal trends in the rejected data are observed.

### TECHNICAL FIELD

The present disclosure generally relates to the field of data processing and to methods and systems for storing and retrieving rejected data. More specifically, the disclosure relates to methods and systems for storing and retrieving data objects that are rejected after being received from an asynchronous user system, the storing and retrieving being accomplished by, for example, relating stored rejected data objects to a current object format for use in a data system.

### BACKGROUND INFORMATION

The complete documentation of electronic business activities is an important part of many business processes. For some businesses, auditing may be essential or even legally required, and all activities related to data manipulation must be documented. In addition to tracking business activities, documented data can also be used to analyze trends and locate inefficiencies and other problems within the business process.

Data processing and storage can be complex in a backend system that receives data from one or more user systems that are not perfectly synchronized with the backend system. When perfect synchrony between all system elements is not possible, errors and data conflicts can arise.

In general, systems document electronic data after first validating the data. If validation fails, that invalid data is not documented. For example, a second system may receive data from a first system via a user interface or a system interface and, after assessing the validity of the data and/or authorizing the first system, the second system may further process and store the valid data, and document these activities. However, if the data is invalid, out of date, or unauthorized, it may be rejected, preventing adequate documentation. If the first system is connected asynchronously to the second system, the submitted data may be lost, and documentation of the submission, rejection, and reasons for the rejection may not occur. However, such information is necessary for complete audits.

Usually, the second system includes a backend that stores data and performs business logic that is hidden from a front-end user of a user system (e.g., “first system”). In an asynchronous environment, the user system may accept a user's changes, and later submit the data object(s) for storage in the backend. The user system can include one or more client devices. For example, the user system may include a network of computers at a local office branch, or alternatively may comprise a single computer or handheld device, such as a phone or PDA. Because the user system may not be synchronized with the backend system, a data object accepted by the user system may be later rejected before or after being received at the backend.

The user system may access the backend, for example, through a middleware layer that coordinates activities between the front end and the backend. The middleware layer may contain a conflict checking service that analyzes the submitted data object(s) for conflicts with existing backend data before relaying the data object(s) to the backend system. In some cases, the middleware is part of the backend system. The data objects sent through the middleware may define requests for data, modifications to existing data, or submissions of entirely new data, such as a document.

Rejected data objects may not be stored in the backend repository. In some systems, an error message may be sent to the client device to alert the user that the data was not successfully stored. However, the activity embodied in the rejected data object may not be tracked, and therefore will not be revealed in an audit. Additionally, if the user forgets to resubmit the data, or changes the data before resubmitting, the rejected data object itself may be lost forever.

Data object rejections can occur for many reasons, but the two most common reasons are an error in validation and a conflict created by outdated data. A validation error can occur, for example, if an equipment number is misspelled, the data object is missing a required component, or data is corrupted during transmission from the client to the backend. On the other hand, a data conflict can occur when a client manipulates data that has already been fundamentally changed on the backend. For example, in a system utilizing middleware, the data sent from the middleware to the client device may change on the backend, causing the data submitted by the client to be out dated. As a result, when the client device modifies the old data object, a conflict occurs and the submitted data may be rejected instead of stored. In that case, the data object (and/or the documentation regarding the rejected modification of the data object) may be lost.

Without a full picture of the many front-end-to-backend transactions, it may be impossible to fully audit the business processes or determine the cause of lost data. For businesses that are legally required to track particular activities, such as aircraft maintenance, the problem may be even more critical. For example, if a user system accepts a user's changes to a maintenance document but the change is not stored in the backend, the maintenance activity may go undetected. Therefore, the business process is incomplete and the audit will fail.

### SUMMARY

In accordance with some embodiments presented herein, a method, computer-readable medium, and system are proposed for storing, retrieving, and displaying a rejected data object. Specifically, an embodiment is configured to receive a data object sent from an asynchronous user system and collect the data object if it is rejected from storage on a backend data repository (where accepted data is otherwise stored). Instead of merely sending an error message and ignoring the rejected data object, the rejected data object is documented by converting the rejected data object into a storage format and storing the data on a storage medium. Information relating the rejected data object in the storage format to a first data model is also stored. This relational information allows the rejected data object to be used by the system in the future, by providing an avenue for translating the rejected data object from the storage format into a first object format consistent with the system's data model at that time.

In certain embodiments, the translation of the rejected data object may occur in response to receiving a request for a first data value included in the rejected data object. The request may include information that is utilized to locate the rejected data object. Then, the rejected data object is translated from a storage format into the first object format by using the stored relational information. A value from the translated rejected data object can then be displayed contemporaneously with a second data value from an accepted data object. In one embodiment, the rejected and accepted data is displayed in chronological order. This may facilitate an audit by allowing a user to see transactions and data that might otherwise be lost. This may also permit a system analyst to correct system problems when abnormal trends in the rejected data are observed.

Additional objects and advantages will be set forth in part in the description which follows, and in part will be obvious from the description, or may be learned by practice of the embodiments. The objects and advantages will be realized and attained by means of the elements and combinations particularly pointed out in the appended claims.

It is to be understood that both the foregoing general description and the following detailed description are exemplary and explanatory only and are not restrictive.

### BRIEF DESCRIPTION OF THE DRAWINGS

The accompanying drawings, which are incorporated in and constitute a part of this specification, illustrate several embodiments and, together with the description, serve to explain the principles included herein.

FIGS. 1A and 1B are overview diagrams of exemplary systems and system components that may be used to store and retrieve rejected data objects, in accordance with some embodiments.

FIGS. 2A and 2B are diagrams of exemplary screens displaying rejected business data contemporaneously with successfully-stored data, in accordance with some embodiments.

FIG. 3 is an exemplary flow chart that includes steps taken to store a rejected data object in a storage format that allows for future retrieval and translation of the data object, in accordance with an embodiment.

FIG. 4 is an exemplary flow chart that includes steps taken to translate and display rejected data contemporaneously with accepted data, in accordance with an embodiment.

FIG. 5 is an exemplary flow chart showing the different data formats of the rejected data during storing data and data retrieval, in accordance with an embodiment.

FIGS. 6A and 6B are diagrams of exemplary relational mappings between a rejected data object and a data object in storage format, in accordance with an embodiment.

FIGS. 7A and 7B are diagrams of exemplary relational mappings between a rejected data object in storage format and a data object in a first object format, in accordance with an embodiment.

### DESCRIPTION OF THE EMBODIMENTS

Reference will now be made in detail to the exemplary embodiments, examples of which are illustrated in the accompanying drawings. Wherever possible, the same reference numbers will be used throughout the drawings to refer to the same or like parts.

Unless otherwise specified, a “data object,” for the purposes of this disclosure, is any data conforming to a particular format. Examples of data objects include an instance of a class of data, one or more records in a database, and/or at least one data value. The “backend” portion of a system is that part of the system responsible for business logic and data storage, and may or may not include the middleware portion of the system. A “data model” may be thought of as a blueprint that specifies the structure of data objects used by the backend or middleware. Therefore, the format of a useable data object may be dictated by the data model in one embodiment.

As already stated, a user system may be any device or satellite system utilized to send data to and/or from the middleware and/or backend system. For example, a user system may comprise a network of computers that is not directly synchronized with the backend system (for example, when either system is not online) such as a network at a local office branch. In this example, work done on the user system is saved as a data object on the user system. Later, when connectivity to the middleware and/or backend system is established, the user system may send the data object for storage to the middleware and/or backend for storage. In addition, the user system may include an automated component that manipulates data rather than receiving direct input from a user. For example, the automated component may create and submit electronic forms without input from the user.

Past systems may reject data objects based on a detected error or conflict, but do not store or retrieve the rejected data in a format useable by a system like the present embodiments. As a result, past systems cannot display the history of interactions related to a rejected data object, and the lost data (and/or the source of the data loss) may go undetected.

Accordingly, in one embodiment, a conflict resolution service, validation service, and/or documentation engine (“rejection services”) may be provided for collecting rejected data and converting the rejected data into a storage format. For example, the storage format may be generic in nature so that rejected data of nearly any type can be stored by using the format. Along with the rejected data, the rejection services may contemporaneously store information that can be later used for relating specific data values and/or object-oriented relationships within the rejected data object in the storage format to a first object format currently being used on the system. This may allow a user to later perform an audit by retrieving rejected data objects and display them contemporaneously with successfully-stored data objects. Contemporaneously displaying accepted and rejected data objects relating to a particular document can also reveal business information that otherwise would be lost, such as the source of a missing edit, or an undocumented broken part. In addition, the rejected data object can be reconstructed and displayed even if the system now uses new hardware, business logic, and/or a new data model.

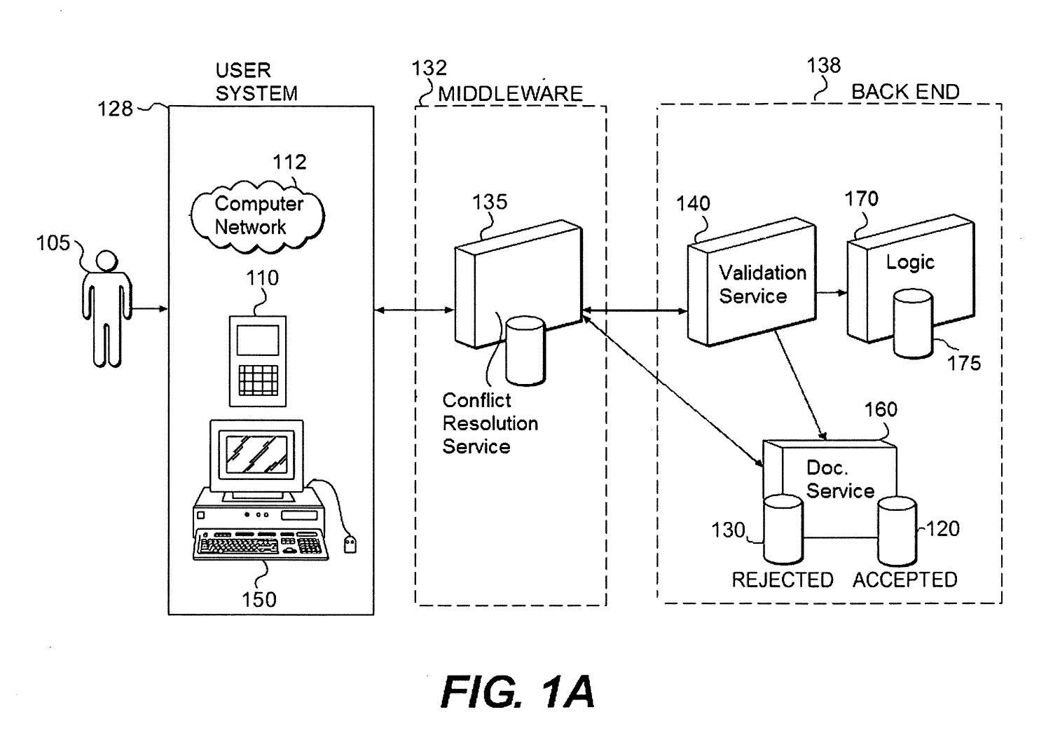

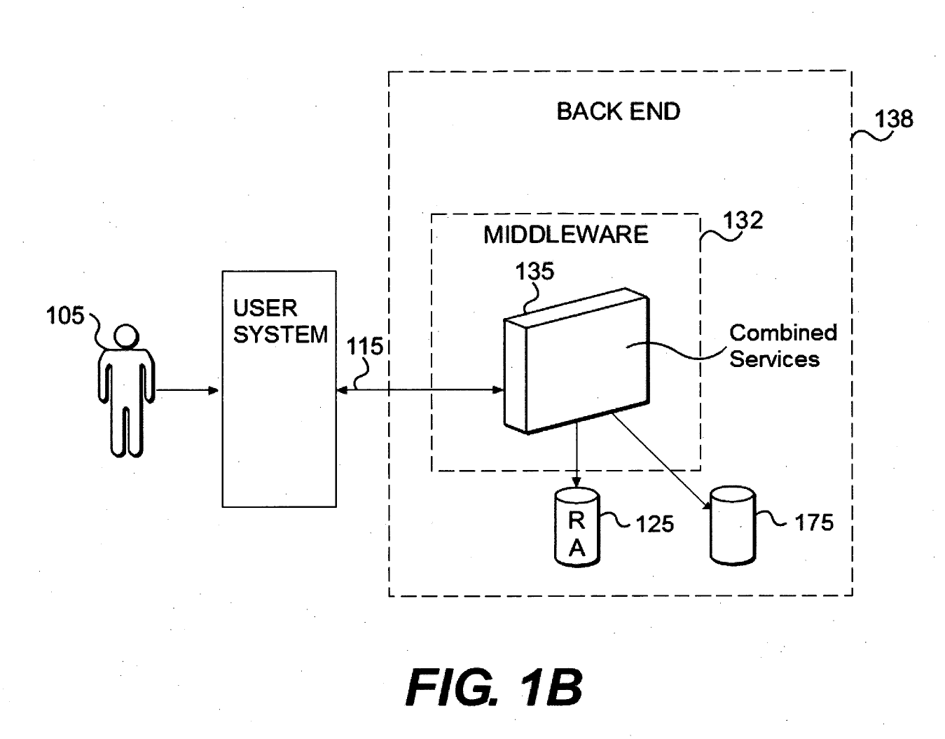

FIGS. 1A and 1B are overview diagrams of exemplary systems and system components that may be used to store and retrieve rejected data objects, in accordance with certain embodiments of the present invention. As shown in FIGS. 1A and 1B, the hardware implementation for storing and retrieving rejected data objects can vary. In addition, the middleware and backend functions (or components) may be distributed differently over one or more servers, depending on the embodiment or implementation of the system.

Turning now to FIG. 1A, a user 105 uses a user system 128, such as a mobile device 110 or a stationary device 150, to submit or modify a data object on the front end 128. Mobile device 110 examples include PDAs, mobile phones, scanners, and laptop computers. Personal computers and workstations are examples of a stationary device 150. In any case, the user system 128 executes front-end software that facilitates sending and receiving data objects to and from a middleware server 135 but that is not perfectly synchronized with the backend data 175. For example, the user system 128 may not have continuous connectivity to the backend 138, and may not be made instantaneously aware of every data change on the backend 138.

The user system 128 may connect to the middleware server 135 over a network, such as the Internet, intranet, local area network, and/or Ethernet. Security measures, such as a virtual private network or encryption, may be used to ensure that the remote transaction is secure. In addition, more than one user system 128 may communicate with middleware server 135 in an embodiment.

The user system 128 may modify data objects stored in the backend 138, such as in backend data repository 175. In some embodiments, the modification is performed locally on the user system 128. For example, the user 105 may open and modify a text document that is copied locally to user system 128 from the backend 138. When the user saves the document, the data object may be accepted by the user system 128. Thereafter, the user system 128 may send the data object to the middleware server 135 to store the change.

The middleware server 135 may be comprised of one or more servers, and includes a processor and a memory. The memory contains instructions that, when executed by the processor, cause the middleware server to operate a conflict resolution service. As used herein, the processor may include multiple processors across one or more servers. The conflict resolution service effectively shields the backend 138 from data objects that conflict with data within backend data repository 175. For example, the conflict resolution service may compare a received data object (such as a document) with an existing version of that data object to determine whether a conflict exists before sending the received data object on to other system services. In addition to the conflict resolution service, the middleware server 135 may be used to periodically re-synchronize data between storages in the backend 138 and user system 128. However, the user system 128 remains asynchronous if it locally persists data.

As shown in FIG. 1B, the middleware server 135 can be part of the backend 138. Alternatively, as shown in FIG. 1A, the middleware server 135 can be totally separate from the backend 138. Therefore, the extent to which the middleware server 135 is responsible for backend business logic (and other system services and processes) may vary according to the embodiment.

If no rejection occurs, the middleware server 135 passes the data object to the backend 138. In the exemplary system illustrated in FIG. 1A, backend services operate on servers 140, 160, and 170. These services may run on different server combinations in various other embodiments. In addition, the services may be combined to produce similar functional results, depending on the embodiment.

Continuing with FIG. 1A, the data object is received by a validation service running on server 140. The validation service may check for data incompatibilities, access restrictions, and other errors before sending the data object to the core backend server 170, which may contain business and data storage logic. If no errors are detected, the data object is successfully stored in data repository 175.

The validity service of validation server 140 may also report the data object to the documentation server 160, which runs a documentation service. The documentation service stores data object information relevant for auditing the system, such as who changed a data object, when the change occurred, what was changed, etc. In one embodiment, the documentation service stores information regarding an accepted data object in a first documentation repository 120.

The first documentation repository 120 may include one or more databases, such as an object-oriented database, a relational database, and/or a flat file, for storing information regarding activities performed on accepted data objects during the normal course of business operations. In addition, the first documentation repository 120 may include one or more servers. The first documentation repository 120 may be included within the backend 138. Alternatively, the first documentation repository may be part of the middleware 132 (or within the middleware server 135), as illustrated in FIG. 1B, ref. 125. In any configuration, the first documentation repository 120 may include a storage medium, such as a hard drive, memory (such as RAM or ROM), writable disk or DVD, tape drive, flash drive, etc. for storing data.

The first documentation repository 120 may, for example, store only activity information regarding data objects accepted for storage in backend data repository 175. However, in another embodiment (such as in FIG. 1B), a single documentation repository may handle auditing information for both accepted and rejected data objects.

In some embodiments, the first documentation repository may be part of backend data repository 175. For example, the accepted data object may consist of more than just the file or document to which it pertains. The document may be represented as a data value within a data object, or the data object may contain a pointer to the document. In any cases, the data object may contain other fields or values for auditing purposes, such as file version, a user associated with the file, a timestamp, the type of action last taken on the file, and other information. By tracking this information in the first documentation repository 120, the system can recreate histories of activities and transactions involving accepted data objects.

If, on the other hand, the data object is rejected by the conflict resolution service or the validation service, the rejected data object may be collected and sent to the documentation service for further processing. In one embodiment, the collection occurs on the middleware server 135. In another embodiment, when a backend 138 process such as the validation service is responsible for the rejection, a backend component such as validation server 140 may collect the data object. Alternatively (or in addition), the backend 138 process may report the rejection to the middleware server 135, for example, by sending an error message. The middleware server 135 may then collect the rejected data object. In yet another embodiment, some other server or service within the backend 138 may collect the rejected data. In some embodiments, the middleware server 132 will also relay an error message to the client device 110 or 150 that submitted the data object.

After collecting the rejected data object, the rejected data object is stored on the second documentation repository 130 with information that can later be used to relate the rejected data object in the storage format to a data model used in the backend 138 by backend data repository 175. This may be accomplished in one embodiment by translating the rejected data object into a format recognizable by the documentation service and sending the rejected data object to the documentation service. The documentation service (or some other service) then converts the rejected data object into the storage format and sends the rejected data object to the second documentation repository 130 for storage. The specific storage format can vary between embodiments. However, the middleware server 135 may store information that allows the middleware server 135 to convert the rejected data object from the storage format to a format consistent with a current data model. Although the processing device responsible for this conversion may be outside of the middleware server 135, the outside processing device should still be considered part of the middleware server 135 for the purposes of this disclosure.

In the example of FIG. 1A, after the rejected data object is converted to the storage format, it is stored on the second documentation repository 130. The second documentation repository 130 may also include one or more databases and/or servers, as described in reference to the first documentation repository 120. In one embodiment, the second documentation repository 130 may be structurally part of, or the same as, the first documentation repository 120 and/or the backend data repository 175. However, in embodiments where the first and second documentation repositories include the same server(s) and/or storage medium(s), the first and second documentation repositories may still be treated as conceptually separate. For example, the data format of the first documentation repository 120 may be different than the storage format of the second documentation repository 130, and the type of data objects stored on each repository may be different. Conceptually, the first documentation repository 120 is distinguishable from the second documentation repository 130 in one embodiment because only the second documentation repository 130 stores rejected data objects. In some embodiments, the second documentation repository 130 is not part of the backend 138, and is included as part of the middleware server(s) 135. In yet another embodiment, the first documentation repository contains a pointer to an associated accepted data object stored in the backend data repository 175, while the second documentation repository actually stores the rejected data object.

In this example, the second documentation repository 130 stores rejected data objects in a storage format. The storage format could be a generic flat-file format that allows for storing multiple types of rejected data objects in a consistent manner. However, the storage format may also be object-oriented or relational in nature, depending on the embodiment. The second documentation repository may also contemporaneously store information that allows the middleware server 135 to later construct the data object from the storage format.

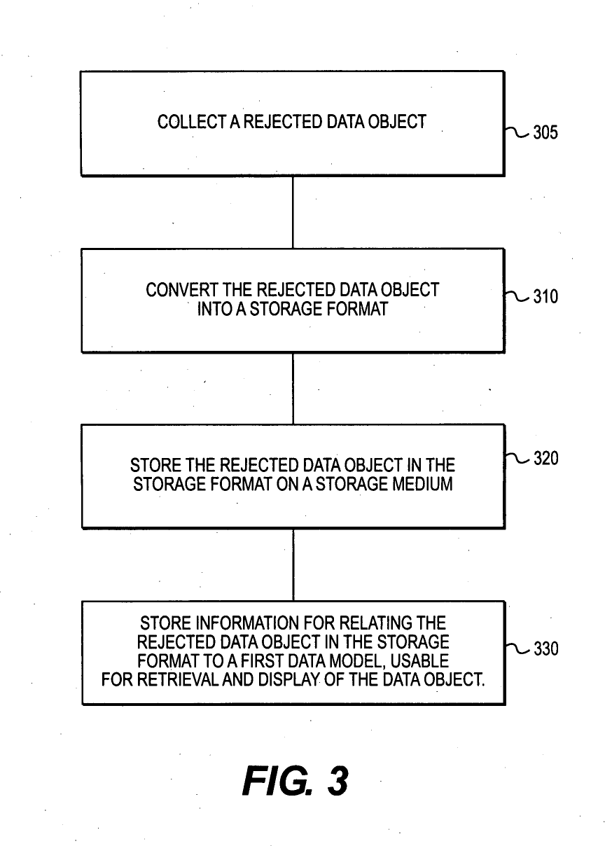

By storing the rejected data object in a storage format on the second documentation repository 130, a user 105 may retrieve the rejected data at a later time. In some embodiments, this allows the user 105 to audit the business process by reconstructing a full picture of business activities, including both rejected data from the second documentation repository 130 and accepted data from the first documentation repository 120 and backend data repository 175. The translation process is described more thoroughly with respect to FIG. 3-7C, below. The translated rejected data and accepted data is then sent to a user system 128. The user system 128 then contemporaneously displays the accepted and rejected data to the user, allowing the user to successfully audit the system.

FIG. 1B is another exemplary system configured in accordance with an embodiment. Unlike the system of FIG. 1A, the middleware server 135 of FIG. 1B is part of the backend 138, and executes a combination of services explained with reference to FIG. 1A. A user modifies a data object on the user system 128. After the user system 128 accepts the modified data object, the data object is sent to the middleware server 135. A service may then reject the data object from storage in a the backend repository 175. At that point, the middleware server 135 converts the rejected data object into a storage format and stores the rejected data object in documentation repository 125. Unlike in FIG. 1A, the documentation repository 125 of FIG. 1B stores auditing data for both accepted and rejected data objects. The middleware server 135 also stores information for use in relating the rejected data object in the storage format to a data model used on the middleware server 135. This relational information may be stored contemporaneously in the documentation repository 125, or may be stored elsewhere in the middleware server 135.

At some later time, the middleware server 135 may receive a request from a user system 128 for a data value contained in the rejected data object. The middleware server then locates the rejected data object and coverts the rejected data object from the storage format into a format consistent with the current data model. The rejected data object (or value within the data object) is then sent to the client device 110 for display to the user 105.

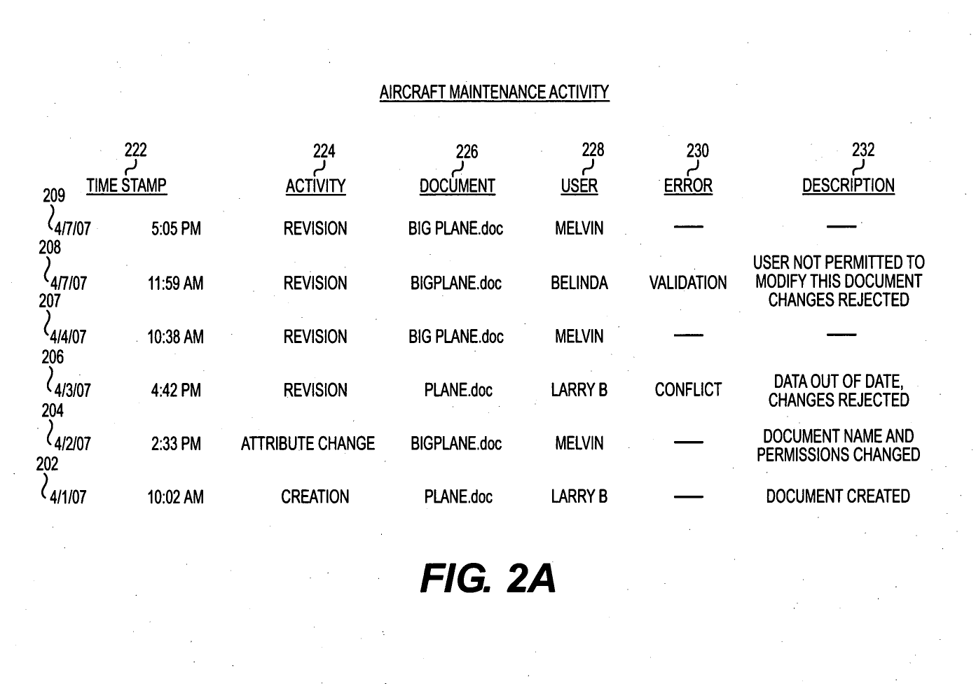

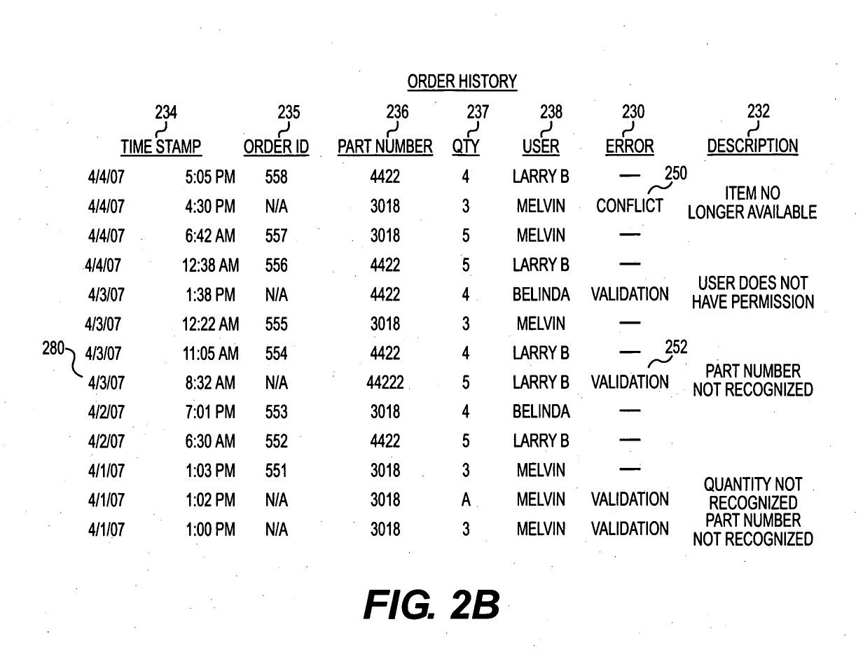

FIGS. 2A and 2B are diagrams of exemplary screens displaying rejected data contemporaneously with successfully-stored data in accordance with an embodiment. Screens of similar type to FIGS. 2A and 2B may be viewed on a client device 150 in some embodiments. Turning to FIG. 2A, an audit report shows various activities on a file that, in this example, describes maintenance of an aircraft. The file belongs to a business that documents each maintenance activity of an aircraft, and tracks which users make and change such documents.

Each row of data 202-209 in FIG. 2A displays one or more data values from a data object. For example, each column 222-232 represents a field to which each data object may have a corresponding data value. The data objects from rows 202, 204, 207, and 209 were received from the backend data repository, which contains accepted data objects, and/or the first documentation repository, which describes actions taken concerning the accepted data objects. Accepted data objects are successfully-stored without being rejected. In this example, the data objects represented at rows 202, 204, 207, and 209 were accepted for storage, and therefore do not contain “error” 230 data values. Conversely, the data objects displayed in rows 206 and 208 are rejected data objects from the documentation repository that stores rejected data objects. In the audit report of FIG. 2A, the data values from the accepted and rejected data objects are arranged chronologically based on the time stamp 222 assigned to each data object activity 224.

At 202, a user 228 named “LarryB” created a document 226 called “Plane.doc.” The next day, at 204, a user identified as “Melvin” performed an attribute change activity 224 of the document 226, changing the name of the document to “BigPlane.doc.” Thereafter, at 206, LarryB attempted a revision on the original document, “Plane.doc.” Because the system detected a conflict 230, the data object containing changes by LarryB was rejected 232. In this example, the conflict may have been detected when the middleware server detected that the document (on the backend) associated with the data object submitted by LarryB was a more recent version of the document than was received from the user system. A rejection can occur for a multitude of other reasons as well. In another instance, the data object may be missing a data value required for storage on the backend server. The extent of error detection and description varies depending upon the particular system using the embodiment.

Displaying rejected data objects contemporaneously with accepted data objects, as shown in FIG. 2B, may also have several advantages in addition to auditing. For example, a system administrator or engineer may notice an unusual frequency of rejections attributable to a certain source or action and implement system-level changes to reduce future rejections. A tool for this analysis is beneficial because a business may increase workflow efficiency by decreasing the frequency of system errors and/or conflicts.

Because the changes made by LarryB at 206 were rejected, the changes were not stored in the backend data repository. In past systems, the changes made by LarryB would remain undocumented, and the changes (and even evidence of the changes) may be lost forever. In this example, LarryB did not resubmit the changes before leaving work, perhaps because the rejection occurred toward the end of his work day. The next morning, Melvin modified the document at 206 but did not incorporate LarryB's rejected changes. As a result, an audit of the document may not disclose LarryB's potentially-critical activities. For instance, the document may not show that LarryB replaced a component within the airplane, which could lead to incorrect presumptions about this component or the airplane in general. Even if LarryB resubmits the changes in an accepted data object, a prior system may no reveal the actual maintenance chronology (e.g., LarryB made changes before Melvin). Therefore, the audit would fail.

However, by using an embodiment to store and display the rejected data objects, as in FIG. 2A, a user can see that LarryB submitted changes at 206. Further, an embodiment may allow the user to view the document 226 submitted at 206 and examine the changes made by LarryB, revealing business data that otherwise would have been lost.

Similarly, at 208, a user 228 named Belinda submitted a revision 224 that was rejected based on a validation error 230. According to the error description 232, Belinda did not have permission to modify the document. However, if Belinda's changes are not implemented by another user, important-business data may be lost. By storing and displaying values from the rejected business object, the source of missing business data and, in some embodiments, even the rejected data object can be retrieved and displayed.

FIG. 2B depicts a similar exemplary audit report that includes both rejected and accepted data objects for part orders. At 252, an order by LarryB was rejected because the part number requested was not recognized. In a system where multiple parts are ordered at once, it may be beneficial to document rejected data objects so that the attempted order is logged even when rejected. This could, for example, help a business to balance order efficiency benefits versus the extra cost of keeping a higher part inventory on hand. Similarly, at 252, a data object was rejected for including an invalid part number. The rejection could be made by a validation service that determines the part number is invalid. A high number of particular rejections could indicate that the part number is listed incorrectly somewhere on the user system, or that user access restrictions are not set correctly on the backend system.

FIG. 3 is an exemplary flow chart that includes steps taken by a middleware server to store a rejected data object in a storage format with relational information that allows for future retrieval and translation of the data object in accordance with one embodiment. First, a user system sends a data object that is subsequently rejected somewhere in the middleware and/or backend. Turning to FIG. 3, at step 305, the middleware server (which, for these purposes, includes backend processes) collects the rejected data object. The method of collection may depend on the method of rejection. For example, if the middleware server rejects the data object, the middleware server may already have access to the object and may simply send that same data object to a documentation service subroutine. In that case, if the middleware server is separate from the backend, a conflict service may collect the reject data object internally, without receiving the rejected data object from the backend. In another embodiment where the data object is rejected from storage in the backend data repository, a backend component, such as the validation service, may send (or return) a rejected data object to the middleware server, where the data is collected. The returned data object may be an error message that includes the data value(s) of the data object sent to the backend repository. Alternatively, the middleware server may retain a pointer to the data object, and may simply follow the pointer to collect the rejected data object.

At step 310, the rejected data object can be converted into a storage format. The storage format may be a generic format that allows the middleware server to reconstruct the documented data object in a format consistent with the backend data model (e.g., a first data model) at a later time. In general, the storage format may include the data value(s) of the rejected object, and data related to the reason for rejection.

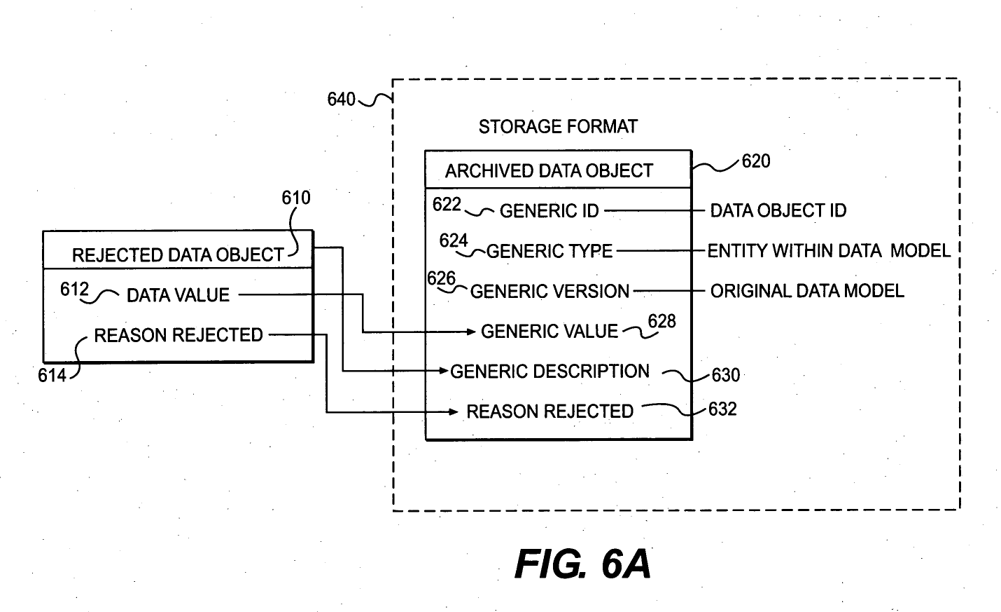

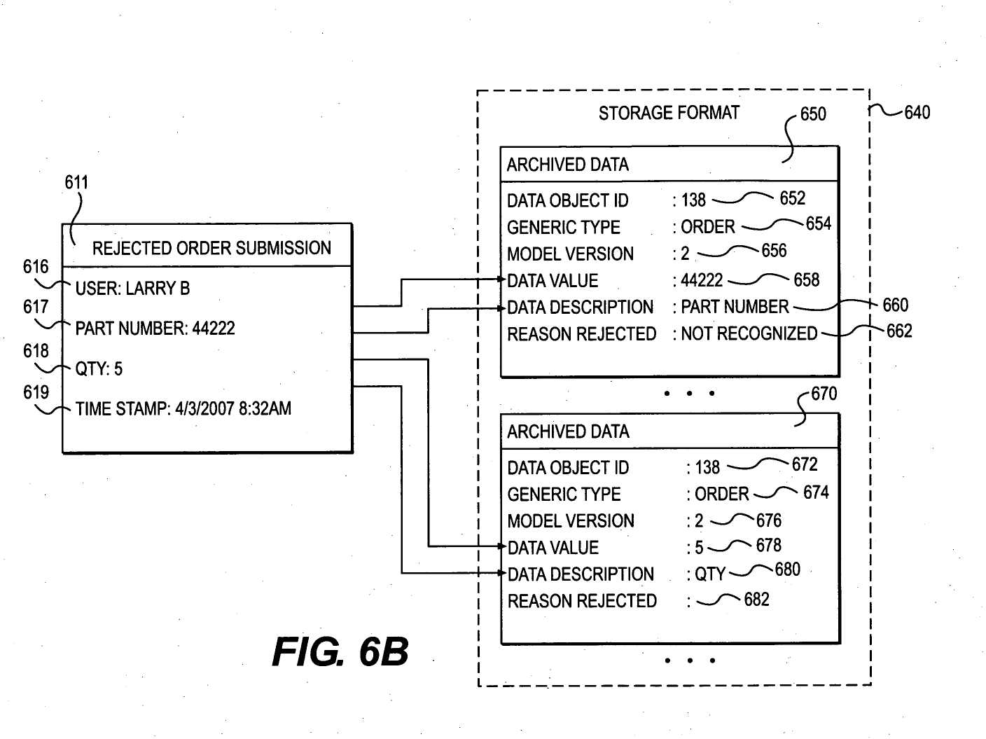

Converting the rejected data object to the storage format may require mapping fields from the rejected data object to the storage format. This process is explained more fully below with respect to, for example, FIGS. 6A and 6B. In general, the middleware server can accomplish the mapping by extracting the data values of the rejected data object and organizing these values in an arrangement that can be understood in the future. If the rejected data object is an error message returned from the backend repository, the middleware server may extract various data values from the error message, and store these values in the storage format. The mapping rules may be stored at a location accessibly by the middleware server or mapping service.

At step 320, the middleware server stores the rejected data object in the storage format on a storage medium. The storage medium may be part of (or include) the documentation repository in some embodiments, and may be part of the backend portion of the system. Possible storage mediums include one or more servers, disks, hard drives, flash drives, memory (such as RAM or ROM), and other media capable of holding electronic data. The data may be stored in an organized fashion, such as with one or more indexes, to facilitate locating the documented rejected data object.

At step 330, the middleware server stores information for relating the rejected data object in the storage format to a first data model. The first data model includes the format with which files are recognized within the business logic in the backend of the system. In some embodiments, the data model also includes a database schema for relating objects in the backend. This schema may also designate tables for holding particular field values in a relational manner.

The relational information varies depending upon the embodiment. In one embodiment, the relational information includes a pointer to metadata that describes the relationships between entities in the backend system to data objects used by the system. This can enable the middleware server to access domain definitions and texts needed to display, visualize, or otherwise use the data in the future. It may also allow for translating the values in the data object into various available logon languages in some embodiments.

In one embodiment, the relational information includes the metadata itself. For example, the metadata may describe the data object that was rejected. The metadata may also describe the mapping of the rejected data object to the backend data model. The middleware server can access the metadata when attempting to translate the rejected data object. Alternatively, the metadata may identify a service within the backend for converting the rejected data object to a currently used format.

The metadata may also include a version identification in some embodiments. The version identification may enable the middleware server to process documented data objects long after the data object format, data fields, and/or service signatures have changed on the backend system. For example, the exact set of metadata used to convert or reformat the stored data object may be selected based on the version identifier.

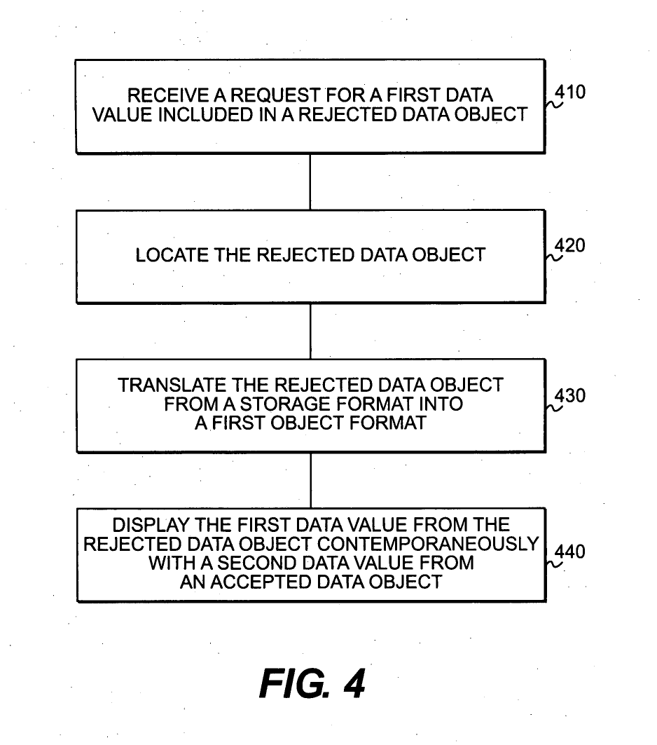

FIG. 4 is an exemplary flow chart that includes steps taken to translate and display rejected data contemporaneously with accepted data in accordance with an embodiment. Turning to FIG. 4, the middleware server may receive a request for a first data value included in the rejected data object at step 410. This request may originate from a client device or an internal process of the middleware server. The middleware may utilize an interface for receiving an external request, such as from a client device. An external request may travel from the client device, over a network, and to an interface that is coupled to the network and to the middleware server. Various operations, such as security validation, error checking, and/or formatting may be performed on the request before or after the request is received.

The request may include one or more values that are utilized for locating the rejected data object. For example, a particular device ID may be included in the request for retrieving rejected data related to that device ID. In some embodiments, the request may not specify a particular data object, and may instead apply to a group of more than one data objects. The scope of allowable queries depends on the embodiment.

At step 420, the middleware server locates the rejected data object. This may done by searching the documentation repository using information included in the request. In some embodiments, the middleware server may submit a query to the documentation repository where the rejected data is stored. The documentation service may locate the rejected data object. In another embodiment, some other service performs the search.

At step 430, the rejected data object may be translated from the storage format into a first object format consistent with a current data model used by the system. For example, the storage format of the rejected data may not be usable within the system without first applying the translation.

In some embodiments, the middleware server can utilize metadata or other relational information to perform the translation. The rejected data object may include a pointer to the appropriate metadata that defines relationships between values of the rejected data object in storage format to the first data format used by the current system. In this way, the metadata may serve as a relational map between data object formats. The relational map can correlate fields, values, and/or objects, depending on the embodiment.

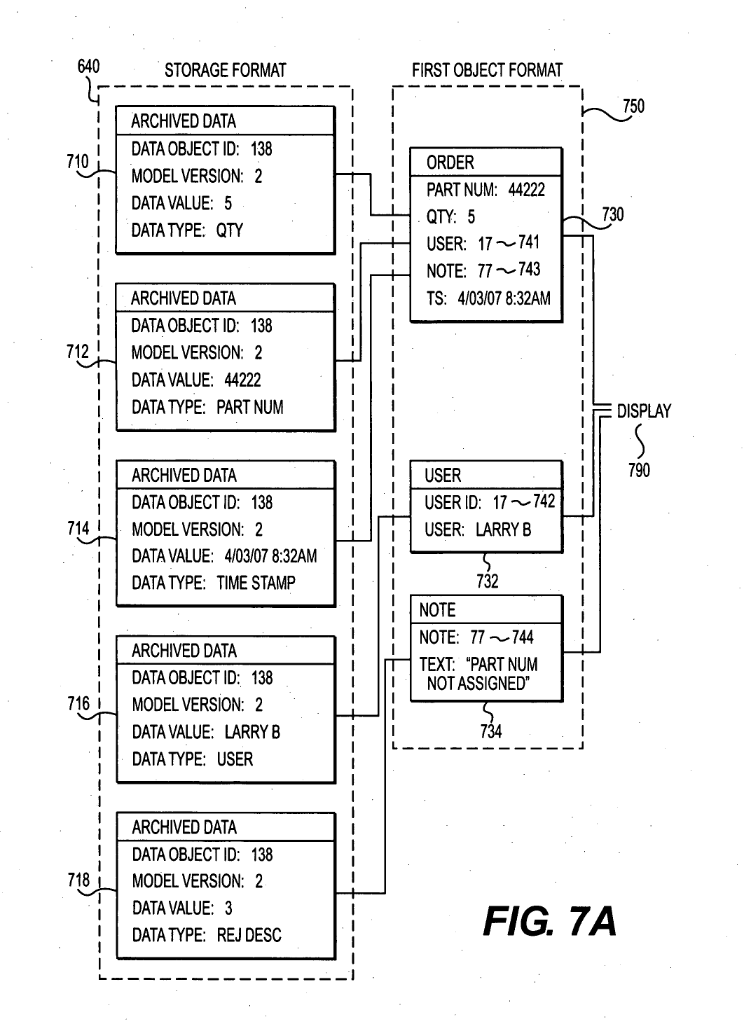

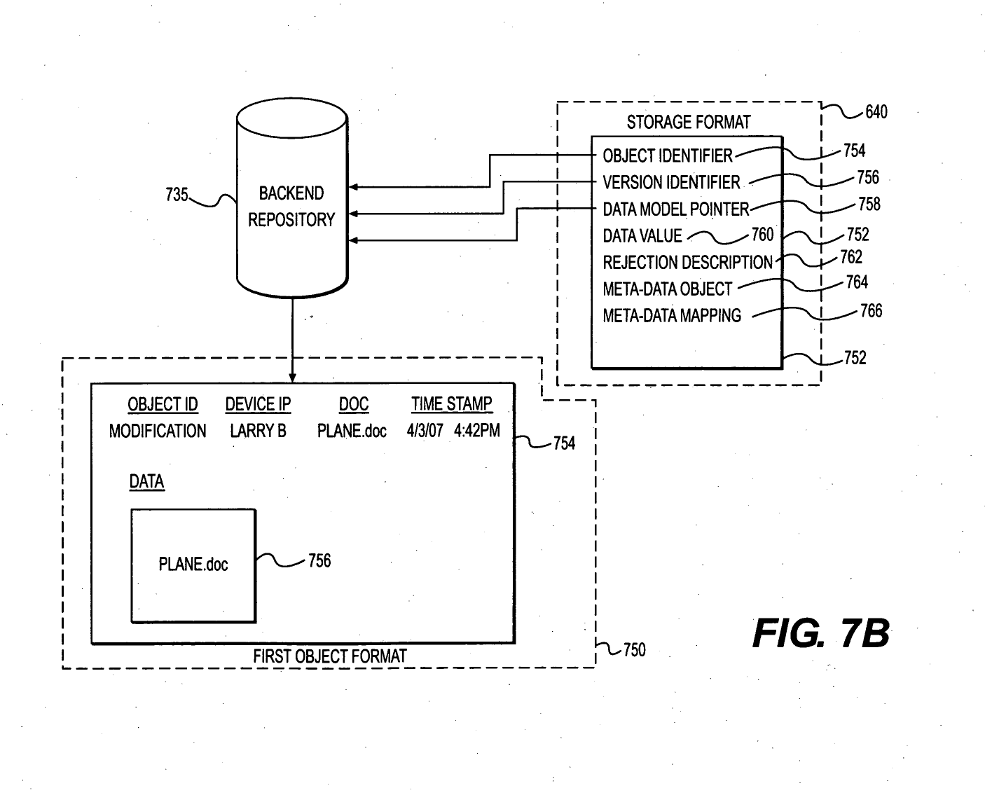

In another instance, the documented rejected data object includes a version identifier that can be used to identify the correct version of metadata to utilize. Once the middleware server establishes the relationships specified in the metadata or other relational information, the middleware server can rearrange and translate the rejected data object values and relationships into the first object format. Example illustrations of this step are explained below with respect to, for example, FIGS. 7A and 7B.

At step 440, after the rejected data object has been formatted according to the first data object format, a data value belonging to the rejected data object can be displayed contemporaneously with another data value from an accepted data object. Exemplary illustrations are provided in FIGS. 2A and 2B, discussed above.

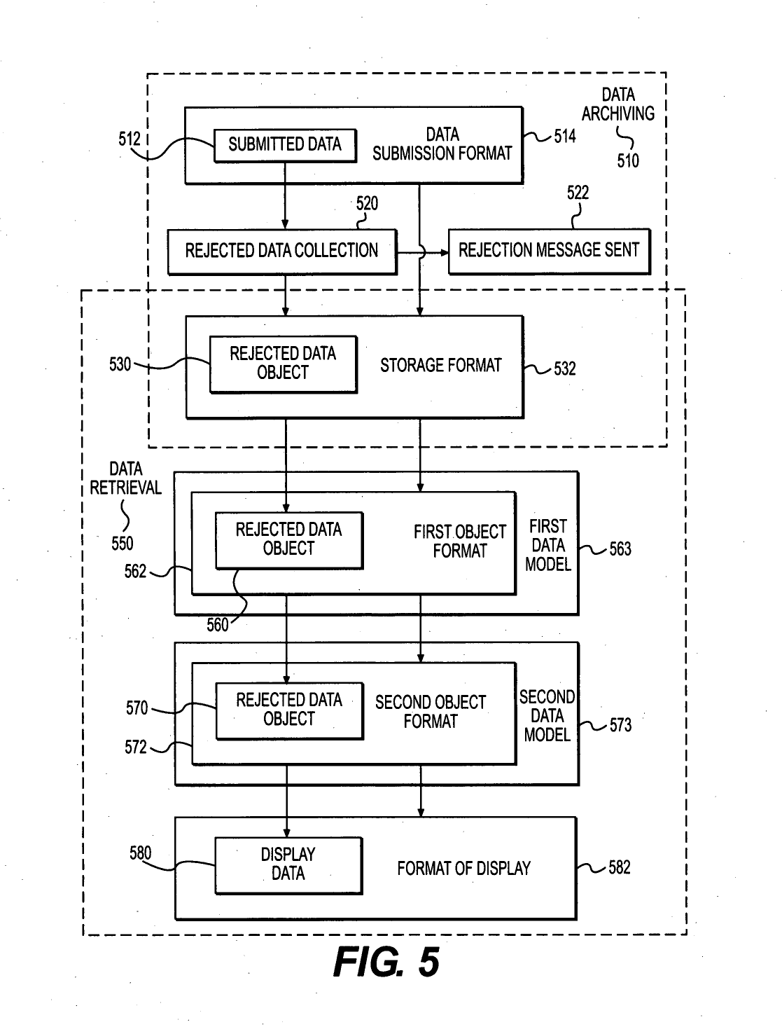

FIG. 5 is an exemplary flow chart showing the different data formats of the rejected data object during data storage 510 and data retrieval 550 in an embodiment. The specific criteria for each depicted data format depends on the embodiment.

First, submitted data 512 is received from a user system by the middleware server in a submission format 514. For example, if a user edits a file on the user system, the submission format may include the file itself, a value indicating a revision was made, a user identification number, and/or a time stamp. These values may be submitted as part of, for example, a data object that is recognized and useable by the middleware server. Alternatively, the middleware server may convert the data object into a first object format before using the data object. In either case, the data object may be submitted when the user system gains connects to the middleware server. Thereafter, a system component may reject the data object for any of the various reasons already discussed.

Once the data object has been rejected, a process begins for collecting the rejected data 520. The process may depend on what part of the system does the rejection. In addition, at 522, a rejection message may be sent to the client device. The rejection message might also be used in the collection process, as previously explained.

The middleware server then converts the collected rejected data values 530 into a storage format 532. The storage format may contain more data than the submission format. For example, the storage format may contain a reason for the rejection, and a generic identifier to distinguish the stored object from other rejected objects stored in the repository. In addition, the storage format may include metadata and/or a pointer to metadata for use in reconstructing the documented data object 530 into a new data format 562 and/or 572 at a later time.

Besides additional data values, the storage format 532 may also be structurally different than the submission format 514. For example, the data may be formatted to fit within a specific database, such as an object oriented datable, a relational database, and/or a flat file. Additionally, the data may be compressed to save storage space, or encrypted differently than the submission data to allow only certain users or processes to access the stored rejection data object. In one aspect, the storage format for a rejected data object may differ from the storage format of audit information for an accepted data object.

The data retrieval 550 process may begin with the rejected data object in 530 in the storage format 532. The rejected data object may be translated into a first object format 562 consistent with a first data model 563 by using metadata or some other relational information. More specifically, the metadata may allow the middleware server to map any field and its data value in the stored data object to the first object format 562 for the same type of data object as would be successfully stored in a backend data repository (for accepted data objects). In one embodiment, the stored data object is related to one or more object types in the backend service, from there to a first object format 562 including tables and/or object relationships, and from there to a rejected data object 560 that conforms with the first object format 562. In this way, the rejected data object 530 can be manipulated as a first format data object 560, even though the successfully stored data objects may rely on a different data object definition 562, different technical implementation, and/or different execution system context than when the submitted data 512 was initially rejected.

In one embodiment, the data retrieval process 550 may also include translating the rejected data object 530 into a second object format 572, consistent with a second data model 573. For example, the second data model 573 may be a later version of the first data model 563. When the first data model is updated to improve system performance or add new features to the system, the documented rejected data object 530 does not become obsolete and/or unusable. So long as the metadata or other relational information is updated to relate the rejected data object to the new (i.e., second) data model, the rejected data object may still be translatable into the second object format 572.

In one embodiment, the rejected data object 530 is translated directly to the second object format 572. In another embodiment, the rejected data object 530 is initially translated into the first object format 562 as described above, and then translated into the second object format 572 from the first data object format 562. For example, the backend system may include additional metadata defining the relationships between the first data model 563 (e.g., a previous data model) and the second data model 573 (e.g., the current data model).

The data may then be translated into a display format 582, such as is illustrated in the examples of FIGS. 2A and 2B. Typically, this involves passing the data object to a client device in a format that the client can display 580, either directly or with additional processing.

FIGS. 6A and 6B are diagrams of exemplary relational mappings between a rejected data object and a data object in storage format, in accordance with certain embodiments of the invention. Both figures are only exemplary, and should not be construed as limiting the storage format contemplated by this disclosure. Many different formats are possible for storing rejected data objects.

Turning to FIG. 6A, a rejected data object 610 containing a data value 612 and rejection reason 614 is depicted. The data value 612 field may contain, for example, a modified file. The “reason rejected” field 614 may contain text that helps the user or other processes within the middleware server or backend components understand why the data object 610 was rejected.

To translate the rejected data object 610 into storage format 640, the data value 612 field is mapped to the generic value 628 field, and the reason rejected field 614 is similarly mapped. In addition, the data object 620 is given a generic identifier 622 for identifying the rejected data object 620 amongst other documented data objects. This relational information may be defined by metadata, or may be pre-programmed into the middleware server.

A generic type 624 may also be defined in some embodiments that relates the documented rejected data object 620 to one or more entities within the first data model. Alternatively or in addition, the generic type 624 may contain a pointer to metadata for establishing the essential relationships. The generic type 624 can also define how to extract multiple values and/or pointers the generic value 628 in creating a data object consistent with the first object model.

In some embodiments, a generic version identifier 626 is used to identify the correct metadata to use in reconstructing the documented rejected data object 620. The version identifier 626 may be useful when a change is made to the data object format of either the client (i.e., front end) data objects, the documented data objects, or the data objects used within the first data model. For example, the same data object type may require different relationships to accommodate changes made to any of the data formats or data models.

A generic description 630 may also be included to allow for manual identification of the documented data object if the automated process fails.

Turning to FIG. 6B, another example relational mapping between a rejected data object 611 and a storage format 640 are shown. (The rejected data object used in this example is displayed in FIG. 2B, reference 280.) In this example, the rejected data object 611 is an order submission with several data values 616, 617, 618, and 619. In one embodiment, the data values may be combined into a single data value for storage in the storage format 640. The relational information may identify how to extract the multiple values from the single data value. However, in the illustrated example, each data value 616, 617, 618, and 619 are mapped to a separate record 650 and 670. In this way, the storage format 640 of FIG. 6B comprises a record for each data value. These records are associated with one another by assigning the same object identification value to each data object id field 652 and 672.

In this example, the rejected data object is broken down into individual fields (e.g., 660 and 680) and values (e.g., 658 and 678). By breaking the rejected data object down into a generic and abstract form for storage, the data object may be easily rebuilt to conform with a first data model at some later date. For example, the generic type 674 may be used to identify the type of object that the rejected data object represents. In this example, the object is an order record. Using metadata that establishes relationships to the current data model, each field identified in the data description can be mapped to the appropriate field(s) for an order within the current data model. The metadata may relate a data value 658, based on the data description 660, to an entity used in a successfully-stored data object of similar type. The model version 656 can be used in this example to identify the correct metadata to use in establishing the relationships.

FIGS. 7A and 7B are diagrams of exemplary relations between a rejected data object in storage format and a data object in a first object format, in accordance with certain embodiments of the invention. Continuing with the example data object from FIG. 6B, FIG. 7A illustrates a translation of that data object from the storage format 640 to a first object format 750, and then to a format for display 790. In this example, the five records comprising an order data object in storage format 640 are translated into three records for representing the order in first object format 750. Records 710, 712, and 714 are combined to create the order record 730. The user data type of record 716 is mapped directly to a user table 732 in the first object format, and the reason for rejection at 718 is mapped to a note record 734. The example mapping of the reason for rejection is not a one-to-one mapping because it requires using the data value 3 to look up a particular text of the first data model to use in first object format 750. In this case, the corresponding text, as specified or related by the metadata, is “Part Num not assigned.” This message may be different depending on the version of metadata used in the translation. For example, the metadata may point to a message in a language other than English.

In one embodiment, there are two separate version identification numbers for the metadata. The first version number may indicate a storage format version used to store the rejected data object. The second version number may indicate a first object format to which the rejected data object should be translated. In this embodiment, the second version identification may be specified by the middleware server or by a client device at the time that the rejected data object is requested, depending on the embodiment. In this way, the same rejected data object may be displayed, for example, in different languages at different client devices.

The metadata is also used to form the necessary relationships between records 730, 732, and 734, which are included in the rejected data object in first object format 750. In this example, the records are relationally linked by defining the same user value 741 of record 730 as value 742 of record 732, and the same note value 743 as note value 744.

After being translated to the first object format 750, the rejected data object can be used by the system to make internal calculations and/or display 790 one or more values from the rejected data object.

FIG. 7B illustrates a translation of a rejected data object 752 in storage format 640 to a predominantly object-oriented data object 754 in first object format 750. The translation utilizes metadata stored in a backend repository 735 to establish relationships between the storage format 640 and the first object format 750. The rejected data object 752 translated in FIG. 7B is also illustrated in FIG. 2A, at row 206.

The rejected data object 752 may contain an object identifier 754 so that the rejected data object 752 can be located amongst other rejected data objects. In addition, the version identifier 756 can indicate the correct metadata to use in translating the rejected data object 752. In this example, the rejected data object 752 contains a pointer to metadata so that the metadata can be located efficiently.

The data value 760 can contain data for populating the various fields of the rejected data object 754 in first object format 750. In this example, the different fields can be mapped from the data value 760 by using metadata that describes which portions of data value 760 correspond to the various fields of object 754. This may also be useful, for example, if the rejected data object 752 is stored in a flat file, the metadata may define how to parse data from the flat file that correlates to each data field of the rejected data object 754 in first object format. These definitions may also be stored as part of the rejected data object 752 in storage format 640, such as by defining the metadata object 764 and/or metadata mapping 766.

The rejected data object 754 in first object format 750 may also contain a file, such as “Plane.doc” 756. This allows the complete reconstruction of a data object, including modifications that might otherwise be lost forever. The file may be stored in a data repository and/or as part of the data value 760. In one embodiment, a user can access the file after the rejected data object has been displayed.

Other embodiments of the invention will be apparent to those skilled in the art from consideration of the specification and practice of the exemplary embodiments of the invention disclosed herein. It is intended that the specification and examples be considered as exemplary only, with a true scope and spirit of the invention being indicated by the following claims.

What is claimed is:

1. A method for storing and retrieving a data object, wherein the data object is received from a first system that connects asynchronously with a second system, the second system comprising a data repository, the data object being subsequently rejected from storage on the data repository of the second system, the method comprising the steps of:
collecting the rejected data object, the rejected data object containing a first value;
converting the rejected data object into a storage format;
storing the rejected data object in the storage format on a storage medium;
storing information for relating the rejected data object in the storage format to a first data model, the information allowing the rejected data object to be translated from the storage format into a first object format consistent with the first data model.

2. The method of claim 1, further comprising:
receiving a request for the first data value included in the rejected data object;
translating the rejected data object from the storage format into the first object format; and
displaying the first data value from the rejected data object contemporaneously with a second data value from an accepted data object.

3. The method of claim 2, wherein the rejected data object in the first object format is usable for displaying the first data value; and
the first data value and second data value are displayed in chronological order.

4. The method of claim 2, further comprising:
translating the rejected data object to a second object format, the second object format being consistent with a second data model that differs from the first data model;
wherein the accepted data object is consistent with the second data model.

5. The method of claim 1, wherein the information establishing the relationship between the rejected data object and the first data model includes a pointer to metadata, the metadata enabling the translation of the rejected data object from the storage format to the first object format.

6. The method of claim 1, wherein the information establishing the relationship between the rejected data object and the first data model includes a version identifier for identifying a version of metadata for use in translating of the rejected data object from the storage format to the first object format.

7. The method of claim 1, wherein the information for establishing a relationship includes metadata that correspondingly links the first data value within the rejected data object to a generic descriptor, the generic descriptor identifying an entity within the first data model.

8. The method of claim 1, wherein the first system is a mobile device; and
the method further comprises the step of rejecting the submitted data object from storage in the data repository.

9. A computer-readable medium containing instructions that cause a processor to perform stages when the processor executes the instructions, the stages comprising:
receiving a request from a user system for a first data value included in a rejected data object, the rejected data object having been rejected from storage on a data repository, the user system being asynchronous with the data repository;
retrieving the rejected data object from a storage medium;
translating the rejected data object from a storage format into a first object format consistent with a first data model by using information relating the rejected data object in the storage format to the first data model, the rejected data object in the first object format being usable for displaying the first data value; and
displaying the first data value from the rejected data object contemporaneously with a second data value from an accepted data object.

10. The computer-readable medium of claim 9, wherein the stages further comprise:
receiving a data object from the user system, the user system having previously accepted the data object, the data object subsequently becoming the rejected data object upon being rejected from storage on the data repository;
collecting the rejected data object;
converting the rejected data object into a storage format;
storing the rejected data object in the storage format on the storage medium; and
storing the information relating the rejected data object in the storage format to the first data model.

11. The computer-readable medium of claim 9, wherein the stages further comprise translating the rejected data object to a second object format consistent with a second data model, the second data model differing from the first data model; and
wherein the accepted data object is consistent with the second data model.

12. The computer-readable medium of claim 9, wherein the information establishing the relationship between the rejected data object and the first data model includes a pointer to metadata on a storage medium, the metadata enabling the processor to reconstruct the rejected data object from the storage format to the first object format.

13. The computer-readable medium of claim 9, wherein the information establishing the relationship between the rejected data object and the first data model includes a version identifier for identifying a version of metadata to use in establishing the relationship between the rejected data object and the first data model.

14. The computer-readable medium of claim 9, wherein the information for establishing a relationship includes metadata that correspondingly links the first data value within the rejected data object to a generic descriptor, the generic descriptor identifying an entity within the first data model.

15. The computer-readable medium of claim 9, wherein the user system includes a mobile device; and
the first data value and second data value are displayed in chronological order.

16. A system for storing and retrieving a rejected data object, the system comprising:
a backend data repository for storing accepted data;
a documentation data repository for storing rejected data; and
a server, operatively coupled to the backend repository and the documentation repository, comprising:
a processor; and
a memory containing instructions executable by the processor, the instructions, when executed, causing the processor to:
receive a data object that is sent from a user system, the user system being asynchronous with the backend data repository; the data object subsequently being rejected from storage in the backend data repository;
convert the rejected data object into a storage format;
store the rejected data object on the documentation data repository along with information establishing a relationship between the rejected data object and a first data model, the information allowing the rejected data object to be translated from the storage format into a first object format consistent with the first data model.

17. The system of claim 16, wherein the instructions further cause the processor to:
receive a request for a first data value included in the rejected data object;
translate the rejected data object into a first object format consistent with the first data model; and
display the first data value from the rejected data object contemporaneously with a second data value included in an accepted data object stored in the backend data repository, the first and second data values being displayed in chronological order.

18. The system of claim 17, wherein the instructions further cause the processor to translate the rejected data object to a second object format, the second object format being consistent with a second data model that differs from the first data model; and
wherein the accepted data object is consistent with the second data model.

19. The system of claim 16, wherein the information establishing the relationship between the rejected data object and a first data model includes a pointer to metadata accessible by the middleware server, the metadata enabling the processor to reconstruct the rejected data object from the storage format to the first object format.

20. The system of claim 16, wherein the information establishing the relationship between the rejected data object and the first data model includes a version identifier for identifying a version of metadata to use in establishing the relationship between the rejected data object and the first data model.

21. The system of claim 16, wherein the user system comprises a mobile device; and
the stages further comprise rejecting the submitted data object from storage in the backend data repository.
